(19) United States
(12) Patent Application Publication
(10) Pub. No.: US 2026/0035566 A1
(43) Pub. Date: Feb. 5, 2026

(54) MICROENCAPSULATED GARDENIA YELLOW PIGMENT AND A PREPARATION METHOD THEREOF

(71) Applicant: Henan Zhongda Hengyuan Biotechnology Stock Co., Ltd., Luohe City (CN)

(72) Inventors: Ziheng JIN, Luohe City (CN); Yanjun Wen, Luohe City (CN)

(21) Appl. No.: 19/262,907

(22) Filed: Jul. 8, 2025

(30) Foreign Application Priority Data
Aug. 2, 2024 (CN) 202411052789.5

(51) Int. Cl. C09B 67/02; B01J 13/12; C08F 290/06; C09B 61/00

(52) U.S. Cl. CPC C09B 67/0097; B01J 13/125; C08F 290/062; C09B 61/00

(57) ABSTRACT

The present invention discloses a microencapsulated gardenia yellow pigment and its preparation method, relating to gardenia yellow pigment microencapsulation technology. The present invention microencapsulates gardenia yellow pigment using a co-encapsulation polymer as the microcapsule wall material. Gardenia yellow pigment exhibits good light and heat resistance under neutral or slightly alkaline conditions; however, its light and heat resistance decreases significantly and it is prone to browning under low pH conditions. To avoid excessive release under acidic conditions, the invention employs a co-encapsulation polymer to construct a pH-responsive microcapsule, which slows down or halts the release rate in acidic conditions, while accelerating the release in alkaline conditions. In this application, polyvinylpyridine is used as a release switch. Polyvinylpyridine is a weakly basic polymer that ionizes at neutral and low pH, and protonates at high pH, causing it to swell and expand the intermolecular gaps, thus speeding up the release rate.

This application claims priority to Chinese Patent Application No. 202411052789.5, filed on Aug. 2, 2024, which is incorporated by reference for all purposes as if fully set forth herein.

### TECHNICAL FIELD

The present invention relates to the field of microencapsulation technology for gardenia yellow pigment, specifically to a microencapsulated gardenia yellow pigment and its preparation method.

### BACKGROUND

Gardenia yellow, also known as crocin, or commonly referred to as yellow gardenia, is a natural pigment belonging to the carotenoid series. It is derived from the fruit of Gardenia, and its main yellow component is the same as the crocin found in saffron, both of which are carotenoid pigments. Due to its vibrant yellow hue, gardenia yellow is widely used in the food industry, commonly added to fruit juice (flavored) beverages, prepared wines, cake surface decorations, ice creams, frozen desserts, puffed foods, jellies, pastries, candies, and chestnut cans, among others, enhancing the vibrant color of these products.

However, the chemical stability of gardenia yellow is significantly affected by the environmental pH. Under neutral or slightly alkaline conditions, gardenia yellow exhibits good light and heat resistance, maintaining its vibrant color without easily fading or deteriorating. However, in low pH acidic environments, its heat and light resistance are greatly reduced, and it is prone to browning. This not only damages the appearance of the product but also limits the application of gardenia yellow in certain acidic environments.

Therefore, to broaden the application range of Gardenia Yellow, particularly for use in acidic environments, researchers have been dedicated to developing a microencapsulation technology. This technology aims to encapsulate Gardenia Yellow in microcapsules, enabling its rapid release in alkaline conditions while slowing down the release rate in acidic conditions. This effectively protects Gardenia Yellow from the effects of acidic environments, maintaining the stability of its color and extending its shelf life.

### SUMMARY OF THE INVENTION

The objective of the present invention is to provide a microencapsulated Gardenia yellow pigment and its preparation method, aiming to address the issues present in the prior art.

To solve the above technical problems, the present invention provides the following technical solution:

A method for preparing microencapsulated gardenia yellow pigment, characterized in that the microencapsulated gardenia yellow pigment is prepared by the following steps:
S1. Under nitrogen protection, according to a mass ratio of 1:3.8˜4.1:0.08˜0.09:0.06˜0.08, pre-treated polyethylene glycol monomethyl ether, vinylpyridine, benzoyl peroxide, and cuprous bromide are added to methanol. After stirring evenly, freeze-dry the mixture using liquid nitrogen, followed by 2˜3 cycles of defrosting with nitrogen gas. Stir for 25˜35 minutes at 25˜30° C., then raise the temperature to 55˜65° C. and react for 8˜12 hours. After the reaction, add 3˜4 times the mass of pre-treated polyethylene glycol monomethyl ether in tetrahydrofuran solution to dilute, stir evenly and stop the reaction. Pass the solution through an alumina chromatography column to remove copper ions, then concentrate the solution using rotary evaporation. After concentration, add 3˜5 times the mass of n-hexane to precipitate. After standing and precipitating, filter and vacuum dry the filtered product to obtain the preliminary co-encapsulation polymer.
S2. Under nitrogen protection, add the preliminary co-encapsulation product, modified methyl methacrylate, benzoyl peroxide, and cuprous bromide to methanol according to a mass ratio of 1:24˜26:1.8˜2.2:0.15˜0.18. After stirring evenly, freeze-dry using liquid nitrogen, followed by nitrogen gas defrosting 2˜3 times. Stir for 25˜35 minutes at 25˜30° C., then raise the temperature to 55˜65° C. and react for 8˜12 hours. After the reaction, add 3˜4 times the mass of the preliminary co-encapsulation product in tetrahydrofuran solution to dilute, stir evenly and stop the reaction. Pass the solution through an alumina chromatography column to remove copper ions, then concentrate the solution using rotary evaporation. After concentration, add 3˜5 times the mass of n-hexane to precipitate. After standing and precipitating, filter and vacuum dry the filtered product to obtain the co-encapsulation polymer.
S3. Add the co-encapsulation polymer to dichloromethane according to a mass ratio of 1:50˜60. Stir to dissolve, and then add 0.6˜0.8 times the mass of the co-encapsulation polymer in gardenia yellow pigment. Ultrasonically disperse for 20˜25 minutes to prepare the oil phase. At a temperature of 25˜30° C., add the oil phase to the aqueous phase in a volume ratio of 1:1. Stir for 3˜5 minutes at a speed of 1800 rpm, then stir for 4˜6 hours at a speed of 600 rpm. After standing to evaporate the organic solvent, perform ultrafiltration and centrifugation. Wash the centrifuged product with deionized water 2˜3 times, then freeze-dry to obtain the microencapsulated gardenia yellow pigment.

As a preferred embodiment, the aqueous phase in step S3 is a 0.4% aqueous solution of polyvinyl alcohol.

As a preferred embodiment, the pre-treated polyethylene glycol monomethyl ether in step S1 is prepared as follows: according to a mass ratio of 1:80˜90, add triethylamine to tetrahydrofuran and stir to make a triethylamine solution for later use. According to a mass ratio of 1:120˜130, add 2-bromoisobutyryl bromide to tetrahydrofuran and stir to make a 2-bromoisobutyryl bromide solution for later use. At a temperature of 0˜5° C., according to a mass ratio of 1:3.5˜3.8, add polyethylene glycol monomethyl ether to toluene, stir evenly, and then add 3.5˜3.7 times the mass of polyethylene glycol monomethyl ether of the triethylamine solution. After mixing well, add 1.1˜1.3 times the mass of polyethylene glycol monomethyl ether of the 2-bromoisobutyryl bromide solution dropwise within 2˜2.5 hours. After dropwise addition, stir the mixture at 25˜30° C. for 36˜48 hours. After the stirring reaction, filter the mixture, and rotary evaporate the filtrate to remove the solvent. Then add 10˜12 times the remaining amount of dichloromethane to dissolve, wash with saturated sodium bicarbonate solution and deionized water 2˜3 times, separate the organic phase, and dry with anhydrous potassium carbonate for 24˜28 hours. After rotary evaporating the solvent from the organic phase, precipitate using 4˜5 times the remaining organic phase of ether. Finally, filter the precipitate and vacuum dry the filtered product to a constant weight to obtain the pre-treated polyethylene glycol monomethyl ether.

As a preferred embodiment, the molecular weight (Mn) of the polyethylene glycol monomethyl ether is 2000.

As a preferred embodiment, the modified methyl methacrylate is prepared as follows: According to a mass ratio of 1:0.4˜0.6, add tetramethylpiperidinyl alcohol to triethylamine, stir evenly, and prepare a tetramethylpiperidinyl alcohol solution. At a temperature of 0˜5° C., add a mass ratio of 1.4˜1.6:20˜22 of acrylol chloride to tetrahydrofuran, stir evenly, and add the tetramethylpiperidinyl alcohol solution dropwise within 1˜1.5 hours. After dropwise addition, stir and react for 46 hours, then allow to stand and filter. Add the filtered product to 20˜25 times its mass of a 50% ethanol aqueous solution for recrystallization, filter, and dry the filtered product in a vacuum oven to a constant weight to obtain the modified methyl methacrylate.

As a preferred embodiment, the co-encapsulation polymer is prepared by co-embedding pre-treated polyethylene glycol monomethyl ether, polyvinylpyridine, and modified methyl methacrylate.

As a preferred embodiment, the pre-treated polyethylene glycol monomethyl ether is modified by grafting with 2-bromoisobutyryl bromide.

As a preferred embodiment, it is prepared by the preparation methods described above.

As a preferred embodiment, the microencapsulated gardenia yellow pigment exhibits good release functionality under alkaline conditions, and the release rate is slower under acidic conditions

As a preferred embodiment, the microencapsulated gardenia yellow pigment has good anti-aging performance, with a performance retention rate greater than 97%.

Compared with the prior art, the beneficial effects achieved by the present invention are as follows:

The present application uses co-encapsulation polymer as the microcapsule wall material to microencapsulate gardenia yellow pigment. Since gardenia yellow pigment exhibits good light and heat resistance under neutral or slightly alkaline conditions, but shows poor heat and light resistance and tends to undergo browning at low pH values, this application aims to prevent excessive release under acidic conditions by employing a co-encapsulation polymer to construct a pH-responsive microcapsule. This allows the release rate to slow down or stop under acidic conditions, while accelerating the release rate under alkaline conditions. Therefore, polyvinylpyridine is used as the release switch. Polyvinylpyridine is a weakly basic polymer that ionizes at medium and low pH and protonates at high pH, causing swelling and enlarging the inter-molecular gaps, which then accelerates the release rate.

In this application, polyethylene glycol monomethyl ether is used as the hydrophilic segment, which not only allows it to quickly bond with gardenia yellow pigment in the oil phase but also helps build an inner hydrophilic layer by gathering the hydrophilic segments inward during microcapsule formation, thus enhancing the overall stability.

Moreover, in this application, methyl methacrylate is modified with a hindered amine, which imparts excellent ultraviolet resistance, improves the overall substrate's service life, and prevents the substrate from yellowing or discoloring. Due to the significant steric hindrance of the hindered amine, it causes the co-encapsulation polymer to form a complete microcapsule structure. The molecular interactions between the side chains at the outer end force the other end inward rapidly, creating a well-formed microcapsule morphology.

### DETAILED DESCRIPTION OF EMBODIMENTS

The following embodiments of the present invention will be described in a clear and complete manner. Clearly, the described embodiments are only a part of the embodiments of the present invention, not all embodiments. Based on the embodiments of the present invention, all other embodiments that can be derived by those skilled in the art without inventive effort are within the scope of protection of the present invention.

To provide a clearer explanation of the method proposed in the present invention, the following embodiments are described in detail. The materials used in the experimental parts of the following embodiments are as follows:

TABLE 1
Materials used in the experimental section

| Name | Specification | Manufacturer |
|---|---|---|
| Cuprous bromide | Analytical grade | Beijing Ouhui Technology |
| | | Co., Ltd. |
| Tetrahydrofuran | 99% | Shandong Yanshuo Chemical |
| | | Co., Ltd. |
| Triethylamine | Analytical grade | Shanghai Aladdin Bio-Chem |
| | | Technology Co., Ltd. |
| 2-Bromoisobutyryl | Analytical grade | Shanghai Aladdin Bio-Chem |
| bromide | | Technology Co., Ltd. |

### Example 1

S1. According to a mass ratio of 1:80, add triethylamine to tetrahydrofuran and stir evenly to prepare a triethylamine solution for later use. According to a mass ratio of 1:120, add 2-bromoisobutyryl bromide to tetrahydrofuran and stir evenly to prepare a 2-bromoisobutyryl bromide solution for later use. At a temperature of 0˜5° C., according to a mass ratio of 1:3.5, add polyethylene glycol monomethyl ether (Mn=2000) to toluene, stir evenly, and then add 3.5 times the mass of polyethylene glycol monomethyl ether of the triethylamine solution. After mixing evenly, dropwise add 1.1 times the mass of polyethylene glycol monomethyl ether of the 2-bromoisobutyryl bromide solution within 2 hours. After dropwise addition, stir at 25° C. for 36 hours. After stirring, filter the mixture and rotary evaporate the filtrate to remove the solvent. Then add 10 times the remaining amount of dichloromethane to dissolve, wash with saturated sodium bicarbonate solution and deionized water 2 times, separate the organic phase, dry with anhydrous potassium carbonate for 24 hours, and rotary evaporate the solvent from the organic phase. Precipitate using 4 times the remaining organic phase of ether. Finally, filter the precipitate and vacuum dry the filtered product to a constant weight to obtain the pre-treated polyethylene glycol monomethyl ether;
S2. According to a mass ratio of 1:0.4, add tetramethylpiperidinyl alcohol to triethylamine and stir evenly to prepare a tetramethylpiperidinyl alcohol solution. At a temperature of 0° C., add 1.4:20 by mass of acryloyl chloride to tetrahydrofuran, stir evenly, and then add the tetramethylpiperidinyl alcohol solution dropwise within 1 hour. After the dropwise addition, stir the mixture for 4 hours, then allow it to stand and filter. Add the filtered product to 20 times its mass of a 50% ethanol aqueous solution for recrystallization, then filter. Dry the filtered product in a vacuum oven to a constant weight to obtain the modified methyl methacrylate;
S2. Under nitrogen protection, according to a mass ratio of 1:3.8:0.08:0.06:5.5, add pre-treated polyethylene glycol monomethyl ether, vinylpyridine, benzoyl peroxide, and cuprous bromide to methanol. Stir evenly, then use liquid nitrogen to freeze and vacuum extract, followed by nitrogen gas defrosting 2˜3 times. Stir for 25 minutes at 25° C., then increase the temperature to 55° C. and react for 8 hours. After the reaction, add 3 times the mass of pre-treated polyethylene glycol monomethyl ether of tetrahydrofuran solution to dilute, stir evenly and stop the reaction. Pass through an alumina column to remove copper ions. After passing through the column, use rotary evaporation to concentrate the solution. After rotary evaporation, add 3˜5 times the remaining solution's mass of n-hexane, let it stand to precipitate, filter the precipitate, and vacuum dry the filtered product to obtain the preliminary co-encapsulated product;
S4. Under nitrogen protection, according to a mass ratio of 1:24:1.8:0.15:7.5, add the preliminary co-encapsulated product, modified methyl methacrylate, benzoyl peroxide, and cuprous bromide to methanol. Stir evenly, then use liquid nitrogen for freeze-vacuum extraction, followed by nitrogen gas defrosting 2 times. Stir for 25 minutes at 25° C., then raise the temperature to 55° C. and react for 8 hours. After the reaction, add 3-4 times the mass of the preliminary co-encapsulated product in tetrahydrofuran solution to dilute, stir evenly and stop the reaction. Pass through an alumina column to remove copper ions. After passing through the column, concentrate the solution using rotary evaporation. After rotary evaporation, add 3˜5 times the remaining solution's mass of n-hexane, let it stand to precipitate, filter the precipitate, and vacuum dry the filtered product to obtain the co-encapsulated polymer;
S5. According to a mass ratio of 1:50, add the co-encapsulated polymer to dichloromethane and stir to dissolve. Then add 0.6 times the mass of the co-encapsulated polymer of gardenia yellow pigment, and sonicate for 20 minutes to prepare the oil phase. At a temperature of 25° C., in a 1:1 volume ratio, add the oil phase to a 0.4% polyethylene glycol aqueous solution. Stir for 3 minutes at a speed of 1800 rpm, then stir for 4 hours at 600 rpm. After stirring, allow the mixture to stand to evaporate the organic solvent, perform ultrafiltration, and centrifuge. Wash the centrifuged product with deionized water 2˜3 times, and freeze-dry the product to obtain the microencapsulated gardenia yellow pigment.

### Example 2

S1. According to a mass ratio of 1:85, add triethylamine to tetrahydrofuran and stir evenly to prepare a triethylamine solution for later use. According to a mass ratio of 1:125, add 2-bromoisobutyryl bromide to tetrahydrofuran and stir evenly to prepare a 2-bromoisobutyryl bromide solution for later use. At a temperature of 3° C., according to a mass ratio of 1:3.6, add polyethylene glycol monomethyl ether (Mn=2000) to toluene, stir evenly, and then add 3.6 times the mass of polyethylene glycol monomethyl ether of the triethylamine solution. After mixing evenly, dropwise add 1.2 times the mass of polyethylene glycol monomethyl ether of the 2-bromoisobutyryl bromide solution within 2.2 hours. After dropwise addition, stir at 28° C. for 40 hours. After stirring, filter the mixture and rotary evaporate the filtrate to remove the solvent. Then add 11 times the remaining amount of dichloromethane to dissolve, wash with saturated sodium bicarbonate solution and deionized water 3 times, separate the organic phase, dry with anhydrous potassium carbonate for 26 hours, and rotary evaporate the solvent from the organic phase. Precipitate using 4.5 times the remaining organic phase of ether. Finally, filter the precipitate and vacuum dry the filtered product to a constant weight to obtain the pre-treated polyethylene glycol monomethyl ether;
S2. According to a mass ratio of 1:0.5, add tetramethylpiperidinyl alcohol to triethylamine and stir evenly to prepare a tetramethylpiperidinyl alcohol solution. At a temperature of 3° C., add 1.5:21 by mass of acryloyl chloride to tetrahydrofuran, stir evenly, and then add the tetramethylpiperidinyl alcohol solution dropwise within 1.2 hours. After the dropwise addition, stir the mixture for 5 hours, then allow it to stand and filter. Add the filtered product to 22 times its mass of a 50% ethanol aqueous solution for recrystallization, then filter. Dry the filtered product in a vacuum oven to a constant weight to obtain the modified methyl methacrylate;
S3. Under nitrogen protection, according to a mass ratio of 1:3.9:0.085:0.07:5.8, add the pre-treated polyethylene glycol monomethyl ether, vinylpyridine, benzoyl peroxide, and cuprous bromide to methanol. Stir evenly, then use liquid nitrogen to freeze and vacuum extract, followed by nitrogen gas defrosting 2-3 times. Stir for 30 minutes at 28° C., then raise the temperature to 60° C. and react for 10 hours. After the reaction, add 3.5 times the mass of the pre-treated polyethylene glycol monomethyl ether in tetrahydrofuran solution to dilute, stir evenly, and stop the reaction. Pass through an alumina column to remove copper ions. After passing through the column, concentrate the solution using rotary evaporation. After rotary evaporation, add 4 times the remaining solution's mass of n-hexane, let it stand to precipitate, filter the precipitate, and vacuum dry the filtered product to obtain the preliminary co-encapsulated product;
S4. Under nitrogen protection, according to a mass ratio of 1:25:2:0.17:7.8, add the preliminary co-encapsulated product, modified methyl methacrylate, benzoyl peroxide, and cuprous bromide to methanol. Stir evenly, then use liquid nitrogen for freeze-vacuum extraction, followed by nitrogen gas defrosting 2 times. Stir for 30 minutes at 28° C., then raise the temperature to 60° C. and react for 10 hours. After the reaction, add 3.5 times the mass of the preliminary co-encapsulated product in tetrahydrofuran solution to dilute, stir evenly, and stop the reaction. Pass through an alumina column to remove copper ions. After passing through the column, concentrate the solution using rotary evaporation. After rotary evaporation, add 3.5 times the remaining solution's mass of n-hexane, let it stand to precipitate, filter the precipitate, and vacuum dry the filtered product to obtain the co-encapsulated polymer.;
S5. According to a mass ratio of 1:55, add the co-encapsulated polymer to dichloromethane and stir to dissolve. Then add 0.7 times the mass of the co-encapsulated polymer of gardenia yellow pigment, and sonicate for 22 minutes to prepare the oil phase. At a temperature of 28° C., in a 1:1 volume ratio, add the oil phase to a 0.4% polyethylene glycol aqueous solution. Stir for 4 minutes at a speed of 1800 rpm, then stir for 5 hours at 600 rpm. After stirring, allow the mixture to stand to evaporate the organic solvent, perform ultrafiltration, and centrifuge. Wash the centrifuged product with deionized water 2-3 times, and freeze-dry the product to obtain the microencapsulated gardenia yellow pigment.

### Example 3

S1. According to a mass ratio of 1:90, add triethylamine to tetrahydrofuran and stir evenly to prepare a triethylamine solution for later use. According to a mass ratio of 1:130, add 2-bromoisobutyryl bromide to tetrahydrofuran and stir evenly to prepare a 2-bromoisobutyryl bromide solution for later use. At a temperature of 5° C., according to a mass ratio of 1:3.8, add polyethylene glycol monomethyl ether (Mn=2000) to toluene, stir evenly, and then add 3.7 times the mass of polyethylene glycol monomethyl ether of the triethylamine solution. After mixing evenly, dropwise add 1.3 times the mass of polyethylene glycol monomethyl ether of the 2-bromoisobutyryl bromide solution within 2.5 hours. After dropwise addition, stir at 30° C. for 48 hours. After stirring, filter the mixture and rotary evaporate the filtrate to remove the solvent. Then add 12 times the remaining amount of dichloromethane to dissolve, wash with saturated sodium bicarbonate solution and deionized water 3 times, separate the organic phase, dry with anhydrous potassium carbonate for 26 hours, and rotary evaporate the solvent from the organic phase. Precipitate using 5 times the remaining organic phase of ether. Finally, filter the precipitate and vacuum dry the filtered product to a constant weight to obtain the pre-treated polyethylene glycol monomethyl ether;
S2. According to a mass ratio of 1:0.6, add tetramethylpiperidinyl alcohol to triethylamine and stir evenly to prepare a tetramethylpiperidinyl alcohol solution. At a temperature of 5° C., add 1.6:22 by mass of acryloyl chloride to tetrahydrofuran, stir evenly, and then add the tetramethylpiperidinyl alcohol solution dropwise within 1.5 hours. After the dropwise addition, stir the mixture for 6 hours, then allow it to stand and filter. Add the filtered product to 25 times its mass of a 50% ethanol aqueous solution for recrystallization, then filter. Dry the filtered product in a vacuum oven to a constant weight to obtain the modified methyl methacrylate;
S3. Under nitrogen protection, according to a mass ratio of 1:4.1:0.09:0.08:6, add pre-treated polyethylene glycol monomethyl ether, vinylpyridine, benzoyl peroxide, and cuprous bromide to methanol. Stir evenly, then use liquid nitrogen to freeze and vacuum extract, followed by nitrogen gas defrosting 3 times. Stir for 35 minutes at 30° C., then increase the temperature to 65° C. and react for 12 hours. After the reaction, add 3.5 times the mass of pre-treated polyethylene glycol monomethyl ether of tetrahydrofuran solution to dilute, stir evenly and stop the reaction. Pass through an alumina column to remove copper ions. After passing through the column, use rotary evaporation to concentrate the solution. After rotary evaporation, add 5 times the remaining solution's mass of n-hexane, let it stand to precipitate, filter the precipitate, and vacuum dry the filtered product to obtain the preliminary co-encapsulated product;
S4. Under nitrogen protection, according to a mass ratio of 1:26:2.2:0.18:8, add the preliminary co-encapsulated product, modified methyl methacrylate, benzoyl peroxide, and cuprous bromide to methanol. Stir evenly, then use liquid nitrogen for freeze-vacuum extraction, followed by nitrogen gas defrosting 3 times. Stir for 35 minutes at 30° C., then raise the temperature to 65° C. and react for 12 hours. After the reaction, add 3.5 times the mass of the preliminary co-encapsulated product in tetrahydrofuran solution to dilute, stir evenly and stop the reaction. Pass through an alumina column to remove copper ions. After passing through the column, concentrate the solution using rotary evaporation. After rotary evaporation, add 5 times the remaining solution's mass of n-hexane, let it stand to precipitate, filter the precipitate, and vacuum dry the filtered product to obtain the co-encapsulated polymer;
S5. According to a mass ratio of 1:60, add the co-encapsulated polymer to dichloromethane and stir to dissolve. Then add 0.8 times the mass of the co-encapsulated polymer of gardenia yellow pigment, and sonicate for 25 minutes to prepare the oil phase. At a temperature of 30° C., in a 1:1 volume ratio, add the oil phase to a 0.4% polyethylene glycol aqueous solution. Stir for 5 minutes at a speed of 1800 rpm, then stir for 6 hours at 600 rpm. After stirring, allow the mixture to stand to evaporate the organic solvent, perform ultrafiltration, and centrifuge. Wash the centrifuged product with deionized water 3 times, and freeze-dry the product to obtain the microencapsulated gardenia yellow pigment.

### Example 4

The only difference from Example 2 is in step S5: where “co-encapsulated polymer” is replaced with “preliminary co-encapsulated product.”

### Example 5

The only difference from Example 2 is in step S5: where “co-encapsulated polymer” is replaced with “polyvinylpyridine.”

### Example 6

The only difference from Example 2 is in step S4: where “modified methyl methacrylate” is replaced with “methyl methacrylate.”

### Embodiment 1

### pH-Responsive Release Test of Microcapsules

The microcapsules prepared in Examples 1-6 are weighed equally and placed in solutions with pH values of 11 (sodium carbonate-sodium bicarbonate buffer), 12 (sodium hydroxide), 2 (hydrochloric acid), and 3 (citric acid-sodium phosphate buffer). After standing for 2 hours, the microcapsules are removed, and the color change of the solution is observed.

TABLE 2
pH-Responsive Release Test Results of Microcapsules

| Sample | pH 11 | pH 12 | pH 2 | pH 3 |
|---|---|---|---|---|
| Example 1 | deep yellow | deep yellow | colorless | light yellow |
| Example 2 | deep yellow | deep yellow | colorless | colorless |
| Example 3 | deep yellow | deep yellow | colorless | colorless |
| Example 4 | deep yellow | deep yellow | light yellow | light yellow |
| Example 5 | colorless | colorless | colorless | colorless |
| Example 6 | light yellow | light yellow | colorless | colorless |

From the experimental data of Examples 1 to 3 in Table 2, it can be observed that the microcapsules prepared by the present invention exhibit good release functionality under alkaline conditions, with a slower release rate under acidic conditions. This is because the co-encapsulation polymer used in this application has pH-responsive properties. When the solution pH increases, the vinylpyridine segment of the polymer becomes protonated, changing from hydrophobic to hydrophilic, causing the structure of the microcapsules to change and releasing the encapsulated agent. This characteristic indicates that using an appropriate co-encapsulation polymer can achieve pH-controlled intelligent release, meeting the application needs of drug controlled release.

In Examples 4 and 5, due to the use of only the preliminary co-encapsulation polymer in Example 4, there was a lack of external chain segments that could force the polymer to compress inward, resulting in the formation of vesicular structures and a decrease in the loading capacity. Additionally, during the formation of the microcapsules, incomplete closure may have occurred, leading to a decrease in pH-responsive ability. In Example 5, since only polyvinylpyridine was used as the wall material, lacking hydrophilic chain segments, it was unable to link with gardenia yellow pigment in the oil phase, resulting in a very low loading capacity of the final microcapsules. The microcapsule structure was not compact enough, and thus could not effectively respond to pH changes, leading to poor release performance.

In Example 6, due to the use of unmodified methyl methacrylate as the outer chain segment, the shorter hydrophobic chains in the microcapsule formation process led to similar phenomena observed in Example 4. The microcapsule structure became denser and less prone to changes, which affected its pH responsiveness and release capacity.

### Embodiment 2

### Microencapsulation's Anti-Aging Performance Test

The microcapsules are placed in pH=11 (sodium carbonate-bicarbonate buffer), pH=12 (sodium hydroxide), pH=2 (hydrochloric acid), and pH=3 (citric acid-sodium phosphate buffer) for 2 hours, then the release rate of the microcapsules is measured.

The microcapsules are placed in a xenon lamp weathering aging test chamber, set at 40° C., 38% humidity, with an irradiation intensity of 230 W/m² at a distance of 26 cm, for 480 hours, simulating natural light exposure to accelerate aging. After aging, the microcapsules are placed again in pH=11 (sodium carbonate-bicarbonate buffer), pH=12 (sodium hydroxide), pH=2 (hydrochloric acid), and pH=3 (citric acid-sodium phosphate buffer) for 2 hours, and the release rate of the microcapsules is measured again. The performance retention rate is calculated as follows:

$$performance retention rate = release rate of microcapsules \\ before aging / release rate of microcapsules after again .$$

TABLE 3
Surface Microstructure Defects Test Results

| Sample | Performance retention rate/% |
|---|---|
| Example 1 | 98.2 |
| Example 2 | 97.4 |
| Example 3 | 98.1 |
| Example 6 | 78.47 |

The anti-aging experiment was conducted only for Examples 1-3 and Example 6, mainly because the previous tests showed that for Examples 4 and 5, if aging tests were performed, the results would either show little difference or a significant discrepancy due to the incomplete microcapsule properties in these examples, making the test results meaningless.

In Table 3, it can be observed that Examples 1-3 exhibit good anti-aging performance, with performance retention rates all exceeding 97%, demonstrating excellent durability. However, in Example 6, the microcapsules' anti-aging performance is poorer, with a performance retention rate of 78.47%. This is mainly due to the use of unmodified methyl methacrylate as the outer chain segment in Example 6, which lacks a hydrophilic chain segment. As a result, the microcapsules are more likely to rupture or undergo structural changes under ultraviolet light, reducing their anti-aging performance. This further illustrates that modified methyl methacrylate as the outer chain segment not only improves the stability of the microcapsules but also effectively enhances their UV resistance, thereby extending the microcapsules' service life in harsh environments. The modified polymer used in Examples 1-3 has better UV stability, which is why it exhibits superior anti-aging performance.

It is evident that the structure and stability of microcapsules have a significant impact on their performance, particularly in terms of pH-responsive release performance and anti-aging performance. Experimental results indicate that the structural stability of microcapsules directly affects their release ability under different pH conditions and their anti-aging performance under UV exposure. Structurally stable microcapsules are better able to control the release of gardenia yellow pigment and maintain good performance under UV exposure. In terms of pH-responsive release performance, microcapsules in Examples 1-3 used modified co-encapsulated polymers, ensuring their structural stability, allowing the microcapsules to respond to pH changes and effectively control the release. In contrast, microcapsules in Examples 4 and 5, which used only preliminary co-encapsulated polymers or polyvinylpyridine, had incomplete structures, making them unable to effectively respond to pH changes, resulting in poor release performance. Regarding anti-aging performance, microcapsules in Examples 1-3 showed good anti-aging ability, with performance retention rates exceeding 97%. These microcapsules were able to effectively resist UV exposure, demonstrating strong stability. However, microcapsules in Example 6, which used unmodified methyl methacrylate as the outer chain segment, exhibited a significant decrease in UV resistance, ultimately affecting their anti-aging performance.

For those skilled in the art, it is evident that the present invention is not limited to the details of the exemplary embodiments described above. Instead, the invention can be realized in other specific forms without departing from the spirit or essential characteristics of the invention. Therefore, the embodiments should be considered as exemplary and non-limiting in nature. The scope of the present invention is defined by the appended claims rather than the above description. Thus, all modifications falling within the meaning and scope of the equivalent elements of the claims are intended to be included within the present invention. No element of the claims should be construed as limiting the scope of the claims unless explicitly stated otherwise.

1. A method for preparing a microencapsulated gardenia yellow pigment, characterized in that the microencapsulated gardenia yellow pigment is prepared by the following steps:
S1, under nitrogen protection, according to a mass ratio of 1:3.8˜4.1:0.08˜0.09:0.06˜0.08, adding pre-treated polyethylene glycol monomethyl ether, vinylpyridine, benzoyl peroxide, and cuprous bromide to methanol, after stirring evenly, freeze-drying by using liquid nitrogen, following by 2˜3 cycles of defrosting with nitrogen gas, stirring for 25˜35 minutes at 25˜30° C., then raising a temperature to 55˜65° C. and reacting for 8˜12 hours, after reaction, adding the pre-treated polyethylene glycol monomethyl ether to tetrahydrofuran, stirring evenly and stopping reaction, passing through an alumina chromatography column to remove copper ions, then concentrating to obtain a precipitate by using rotary evaporation, after concentration, adding n-hexane to the precipitate, after standing and precipitating, filtering and vacuum drying to obtain a preliminary co-encapsulation polymer;
S2, under nitrogen protection, adding the preliminary co-encapsulation product, modified methyl methacrylate, benzoyl peroxide, and cuprous bromide to methanol according to a mass ratio of 1:24˜26:1.8˜2.2:0.15˜0.18, stirring evenly, freeze-drying by using liquid nitrogen, following by nitrogen gas defrosting 2˜3 times, stirring for 25˜35 minutes at 25˜30° C., then raising a temperature to 55˜65° C. and reacting for 8˜12 hours, after reaction, adding 3˜4 times a mass of the preliminary co-encapsulation product in tetrahydrofuran solution to dilute, stirring evenly and stopping reaction, passing through an alumina chromatography column to remove copper ions, then concentrating by using rotary evaporation to obtain a precipitate, after concentration, adding n-hexane to the precipitate, after standing and precipitating, filtering and vacuum drying to obtain a co-encapsulation polymer; and
S3, adding the co-encapsulation polymer to dichloromethane according to a mass ratio of 1:50˜60, stirring to dissolve, and then adding 0.6˜0.8 times a mass of the co-encapsulation polymer in gardenia yellow pigment, ultrasonically dispersing for 20˜25 minutes to prepare an oil phase, at a temperature of 25˜30° C., adding the oil phase to an aqueous phase in a volume ratio of 1:1, stirring for 3˜5 minutes at a speed of 1800 rpm, then stirring for 4˜6 hours at a speed of 600 rpm, after standing to evaporate dichloromethane, performing ultrafiltration and centrifugation, washing with deionized water 2˜3 times, then freeze-drying to obtain the microencapsulated gardenia yellow pigment.

2. The method for preparing the microencapsulated gardenia yellow pigment according to claim 1, wherein the aqueous phase in step S3 is a 0.4% aqueous solution of polyvinyl alcohol.

3. The method for preparing the microencapsulated gardenia yellow pigment according to claim 1, wherein the pre-treated polyethylene glycol monomethyl ether in step S1 is prepared as follows: according to a mass ratio of 1:80˜90, adding triethylamine to tetrahydrofuran and stirring to obtain a triethylamine solution for later use, according to a mass ratio of 1:120˜130, adding 2-bromoisobutyryl bromide to tetrahydrofuran and stirring to obtain a 2-bromoisobutyryl bromide solution, at a temperature of 0˜5° C., according to a mass ratio of 1:3.5˜3.8, adding polyethylene glycol monomethyl ether to toluene, stirring evenly, and then adding polyethylene glycol monomethyl ether to the triethylamine solution, after mixing well, adding 1.1˜1.3 times a mass of polyethylene glycol monomethyl ether of the 2-bromoisobutyryl bromide solution dropwise within 2˜2.5 hours, after dropwise addition, stirring at 25˜30° C. for 36˜48 hours, after stirring reaction, filtering and rotary evaporating to remove the solvent, then adding dichloromethane to dissolve, washing with saturated sodium bicarbonate solution and deionized water 2˜3 times, separating an organic phase, and drying with anhydrous potassium carbonate for 24˜28 hours, after rotary evaporating solvent from the organic phase, precipitating by using ether to obtain a precipitate, and finally filtering the precipitate and vacuum drying to a constant weight to obtain the pre-treated polyethylene glycol monomethyl ether.

4. The method for preparing the microencapsulated gardenia yellow pigment according to claim 3, wherein the molecular weight (Mn) of the polyethylene glycol monomethyl ether is 2000.

5. The method for preparing the microencapsulated gardenia yellow pigment according to claim 1, wherein the modified methyl methacrylate is prepared as follows: according to a mass ratio of 1:0.4˜0.6, adding tetramethylpiperidinyl alcohol to triethylamine, stirring evenly, and preparing a tetramethylpiperidinyl alcohol solution, at a temperature of 0˜5° C., adding a mass ratio of 1.4˜1.6:20˜22 of acrylol chloride to tetrahydrofuran, stirring evenly, and adding the tetramethylpiperidinyl alcohol solution dropwise within 1˜1.5 hours, after dropwise addition, stirring and reacting for 46 hours, then allowing to stand and filtering, adding a 50% ethanol aqueous solution for recrystallization, filtering and drying in a vacuum oven to a constant weight to obtain the modified methyl methacrylate.

6. The method for preparing the microencapsulated gardenia yellow pigment according to claim 1, wherein the co-encapsulation polymer is prepared by co-embedding pre-treated polyethylene glycol monomethyl ether, polyvinylpyridine, and modified methyl methacrylate.

7. The method for preparing the microencapsulated gardenia yellow pigment according to claim 1, wherein the pre-treated polyethylene glycol monomethyl ether is modified by grafting with 2-bromoisobutyryl bromide.

8. A microencapsulated gardenia yellow pigment, wherein the microencapsulated gardenia yellow pigment is prepared by the method according to claim 1.

9. The microencapsulated gardenia yellow pigment according to claim 8, wherein the microencapsulated gardenia yellow pigment exhibits good release functionality under alkaline conditions, and a release rate is slower under acidic condition.

10. The microencapsulated gardenia yellow pigment according to claim 8, wherein the microencapsulated gardenia yellow pigment has good anti-aging performance, with a performance retention rate greater than 97%.
